(19) United States
(12) Patent Application Publication
(10) Pub. No.: US 2024/0363089 A1
(43) Pub. Date: Oct. 31, 2024

(54) DISPLAY DEVICE AND ASSOCIATED CONTROL METHOD

(71) Applicant: Realtek Semiconductor Corp., HsinChu (TW)

(72) Inventors: Chen-Wei Liu, HsinChu (TW); Yun-Ting Tsai, HsinChu (TW)

(73) Assignee: Realtek Semiconductor Corp., HsinChu (TW)

(21) Appl. No.: 18/243,089

(22) Filed: Sep. 6, 2023

Related U.S. Application Data
(60) Provisional application No. 63/462,254, filed on Apr. 27, 2023.

(30) Foreign Application Priority Data
Aug. 1, 2023 (TW) 112128859

(51) Int. Cl. H04M 1/23; H04M 1/60; H04M 1/72439

(52) U.S. Cl. CPC G09G 5/12; G06F 3/14; H04M 1/233; H04M 1/236; H04M 1/6066; H04M 1/72439; G09G 2370/16

(57) ABSTRACT

The present invention provides a control method of a display device, wherein the control method includes the steps of: connecting to an electronic device by using a first communication module, and receiving video signals from the electronic device to display on a display panel; and connecting to the electronic device by using a wireless communication module; and receiving a first control signal from an input device through a second communication module, generating a second control signal according to the first control signal, and transmitting the second control signal to the electronic device through the wireless communication module to control an operation of the electronic device.

### CROSS REFERENCE TO RELATED APPLICATIONS

This application claims the benefit of U.S. Provisional Application No. 63/462,254, filed on Apr. 27, 2023. The content of the application is incorporated herein by reference.

### BACKGROUND OF THE INVENTION

### 1. Field of the Invention

The present invention relates to a method for a display device agent to transmit control signals.

### 2. Description of the Prior Art

When a user uses an electronic device, such as a mobile phone, to transmit audio-video data to a display device for display, if the user wants to control the mobile phone through a keyboard or mouse connected to the display device, it needs to use a display device agent control mechanism, so that the control signals of the keyboard or mouse are transmitted to the mobile phone through the display device. However, the current mechanisms for the display device agent to transmit control signals are limited to specific signal types, thus causing inconvenience to the users.

### SUMMARY OF THE INVENTION

It is therefore an objective of the present invention to provide a control method of a display device, to solve the problems described in the prior art.

According to one embodiment of the present invention, a control method of a display device comprises the steps of: connecting to an electronic device by using a first communication module, and receiving image signals from the electronic device to display on a display panel; and connecting to the electronic device by using a wireless communication module; and receiving a first control signal from an input device through a second communication module, generating a second control signal according to the first control signal, and transmitting the second control signal to the electronic device through the wireless communication module to control an operation of the electronic device.

According to one embodiment of the present invention, a display device comprising a first communication module, a second communication module, a wireless communication module and a processing circuit configured to control an operation of the display device is disclosed. The processing circuit is configured to perform the steps of: connecting to an electronic device by using the first communication module, and receiving image signals from the electronic device to display on a display panel; connecting to the electronic device by using the wireless communication module; and receiving a first control signal from an input device through the second communication module, generating a second control signal according to the first control signal, and transmitting the second control signal to the electronic device through the wireless communication module to control an operation of the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a display device according to one embodiment of the present invention.

FIG. 2 is a flowchart of a control method of the display device according to one embodiment of the present invention.

### DETAILED DESCRIPTION

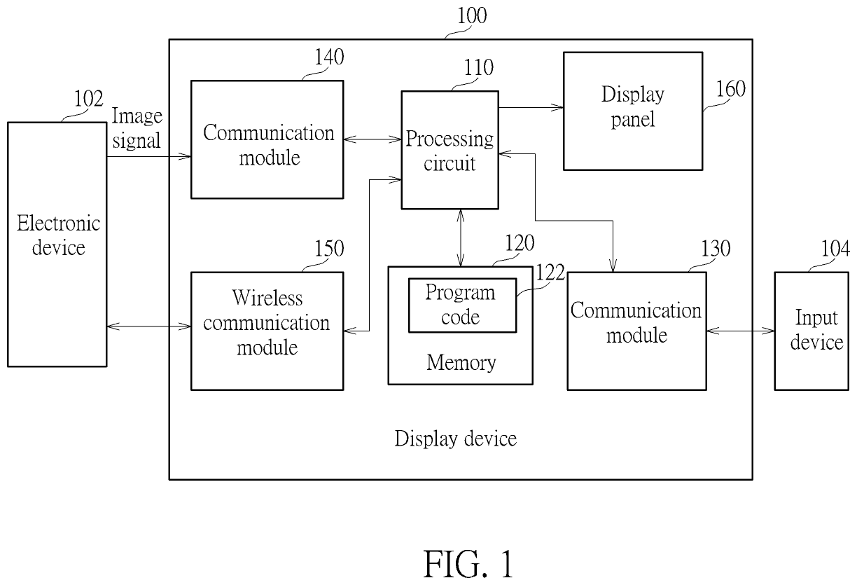

FIG. 1 is a diagram illustrating a display device 100 according to one embodiment of the present invention. As shown in FIG. 1, the display device 100 comprises a processing circuit 110, a memory 120, a communication module 130, a communication module 140, a wireless communication module 150 and a display panel 160, wherein the memory 120 comprises at least one program code 122. In this embodiment, the display device 100 can be any device capable of displaying images, such as a TV or a desktop display, and the display device 100 can receive audio and video/image data from an electronic device 102, and display the video data from the electronic device 102 on the display panel 160. In addition, the user can control the operation of the display device 100 and the electronic device 102 through an input device 104 connected to the display device 100. In one embodiment, the electronic device 102 can be a smart phone, a tablet computer, a notebook or any electronic device that can generate image data to the display device 100 for playback, and the input device 104 can be a wired/wireless mouse, a wired/wireless keyboard, or any other human interface device (HID) that can control the operation of the display device 100.

The communication module 130 can be any wireless communication module or wired communication module that can be connected to the external input device 104. For example, the communication module 130 may comprise a universal serial bus (USB) interface circuit, and communicate with the input device 104 through a USB transmission line. The communication module 130 may comprise a Bluetooth interface circuit or a Wi-Fi interface circuit, and communicate with the input device 104 through Bluetooth communication protocol or Wi-Fi communication protocol.

The communication module 140 can be any wireless communication module or wired communication module that can be connected to the external electronic device 102. For example, the communication module 140 may comprise a high-definition multimedia interface (HDMI) interface circuit, a displayport (DP) interface circuit or a USB type-C interface circuit, and the electronic device 102 can transmit image data to the communication module 140 through related protocols to playback. The communication module 140 may comprise a Wi-Fi interface circuit to communicate with the electronic device 102 through wireless display standards such as miracast or airplay.

The wireless communication module 150 may comprise a Wi-Fi interface circuit to communicate with the electronic device 102 through a Wi-Fi direct mechanism. The wireless communication module 150 may comprise a Bluetooth interface circuit to communicate with the electronic device 102 through the Bluetooth protocol.

The memory 120 can be any suitable storage device, such as a flash memory or a read-only memory (ROM). The program code 122 may comprise a driver and related parameters for controlling the display device 100, such as a Wi-Fi driver or a Bluetooth driver. In addition, the processing circuit 110 can read the program code 122 from the memory 120 to control the operation of the communication modules 130, the communication module 140, the wireless communication module 150 and other components.

In the embodiment shown in FIG. 1, the display device 100 can receive the control signal from the input device 104 and transmit the control signal to the electronic device 102 as an agent, so that the user can control the operation of the electronic device 102 through the input device 104. Specifically, firstly, the communication module 140 is connected to the electronic device 102, and the processing circuit 110 receives image data from the electronic device 102 through the communication module 140, and processes the image data and displays the processed image data on the display panel 160. In addition, in this embodiment, the electronic device 102 can display its entire screen content or a display content of an audio-video player on the display panel 160 through the projection mechanism. Then, the processing circuit 110 controls the wireless communication module 150 to establish a connection with the electronic device 102.

In one embodiment, the communication module 140 and the wireless communication module 150 use different communication protocols, links or channels to communicate with the electronic device 102. For example, the communication module 140 can connect to the electronic device 102 by using HDMI, DP or USB Type-C specifications, while the wireless communication module 150 may use Wi-Fi or Bluetooth to connect to the electronic device 102. In another example, the communication module 140 can use the Wi-Fi mechanism to connect to the electronic device 102, while the wireless communication module 150 may use Bluetooth mechanism to connect to the electronic device 102. In another example, both the communication module 140 and the wireless communication module 150 can be connected to the electronic device 102 through the Wi-Fi mechanism, but the communication module 140 and the wireless communication module 150 respectively establish links with the electronic device 102 and use different channels to connect to the electronic device 102.

In one embodiment, the communication module 130 and the wireless communication module 150 can be the same or different types of communication modules, and the processing circuit 110 can obtain the mouse/keyboard control signals, such as moving coordinates of the mouse, click commands of the mouse, input characters and symbols of the keyboard, etc., from the communication module 130 through the related driver in the program code 122. Then, the processing circuit 110 transmits the mouse/keyboard control signals to the electronic device 102 through the wireless communication module 150.

In one example, both the communication module 130 and the wireless communication module 150 are Bluetooth modules, and the communication module 130 and the wireless communication module 150 can share some circuits. Regarding the relationship between the display device 100 and the input device 104, the input device 104 serves as a client and the display device 100 serves as a server, that is, the input device 104 can broadcast a packet indicating that the input device 104 is a mouse or a keyboard, and the processing circuit 110 uses the communication module 130 to scan the surrounding Bluetooth devices and performs pairing and connecting operations with the input device 104. On the other hand, regarding the relationship between the display device 100 and the electronic device 102, the display device 100 serves as a client and the electronic device 102 serves as a server, that is, the display device 100 can broadcast a packet indicating that the display device is a mouse or a keyboard (that is, disguised as a mouse or keyboard), and the electronic device 102 scans the surrounding Bluetooth devices and performs pairing and connecting operation with the display device 100.

After the processing circuit 110 controls the wireless communication module 150 to establish a connection with the electronic device 102, the processing circuit 110 can transmit the control signal from the input device 104 to the electronic device 102 through the wireless communication module 150. Specifically, when the processing circuit 110 receives a first mouse/keyboard control signal through the communication module 130, the processing circuit 110 will properly convert or adjust the first mouse/keyboard control signal to generate a second mouse/keyboard control signal that meets the specifications of the wireless communication module 150 and send it to the electronic device 102, so that the electronic device 102 performs the corresponding moving coordinates of the mouse, click commands of the mouse, input characters and symbols of the keyboard, etc., according to the second mouse/keyboard control signal. The input characters, symbols, and/or the corresponding mouse/keyboard actions will be displayed on the screen of the electronic device 102.

In addition, since the screen content of the electronic device 102 is projected on the display panel 160 through the communication module 140, the display panel 160 will also display the moving coordinates of the mouse, the click of the mouse, the input characters or symbols of the keyboard, etc.

As mentioned above, since the display device 100 transmits a control signal to the electronic device 102 through the wireless communication module 150 different from the communication module 140 used to receive image signals to control its operation, the display device 100 of this embodiment can serve as an agent to transmit the control signal to the electronic device 102 by using any audio-video transmission protocol, so as to facilitate the user's operation.

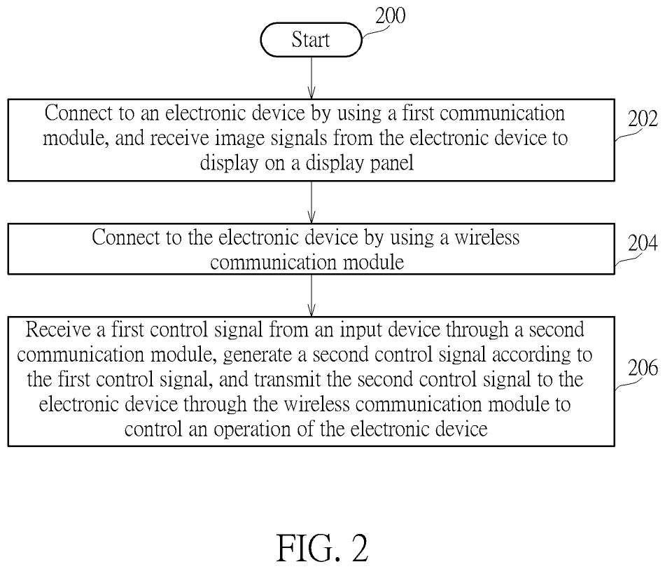

FIG. 2 is a flowchart of a control method of the display device 100 according to one embodiment of the present invention. Referring to the above embodiments, the flow of the control method is described as follows.

Step 200: the flow starts.

Step 202: connect to an electronic device by using a first communication module, and receive image signals from the electronic device to display on a display panel.

Step 204: connect to the electronic device by using a wireless communication module.

Step 206: receive a first control signal from an input device through a second communication module, generate a second control signal according to the first control signal, and transmit the second control signal to the electronic device through the wireless communication module to control an operation of the electronic device.

Those skilled in the art will readily observe that numerous modifications and alterations of the device and method may be made while retaining the teachings of the invention. Accordingly, the above disclosure should be construed as limited only by the metes and bounds of the appended claims.

1. A control method of a display device, comprising:
connecting to an electronic device by using a first communication module, and receiving image signals from the electronic device through the first communication module to display on a display panel;
connecting to the electronic device by using a wireless communication module; and
receiving a first control signal from an input device through a second communication module, generating a second control signal according to the first control signal, and transmitting the second control signal to the electronic device through the wireless communication module to control an operation of the electronic device;
wherein the first communication module is different from the wireless communication module; and the first communication module and the wireless communication module use different communication protocols, different links or different channels to communicate with the electronic device.

2. The control method of claim 1, wherein the input device is a mouse or a keyboard, and the first control signal is a mouse control signal or a keyboard control signal.

3. The control method of claim 1, wherein the image signal is screen content of the electronic device, or a display content of an audio-video player on a display panel of the electronic device.

4. (canceled)

5. The control method of claim 1, wherein the second communication module and the wireless communication module are Bluetooth communication modules, and the control method further comprises:
connecting to the electronic device through the second communication module,
wherein the input device is a client, and the display device is a server; and
the steps of connecting to the electronic device through the wireless communication module comprises:
connecting to the electronic device through the wireless communication module, wherein the display device is the client, and the electronic device is the server.

6. A display device, comprising:
a first communication module;
a second communication module;
a wireless communication module; and
a processing circuit, configured to control an operation of the display device;
wherein the processing circuit is configured to perform the steps of:
connecting to an electronic device by using the first communication module, and receiving image signals from the electronic device through the first communication module to display on a display panel;
connecting to the electronic device by using the wireless communication module; and
receiving a first control signal from an input device through the second communication module, generating a second control signal according to the first control signal, and transmitting the second control signal to the electronic device through the wireless communication module to control an operation of the electronic device;
wherein the first communication module is different from the wireless communication module; and the first communication module and the wireless communication module use different communication protocols, different links or different channels to communicate with the electronic device.

7. The display device of claim 6, wherein the input device is a mouse or a keyboard, and the first control signal is a mouse control signal or a keyboard control signal.

8. The display device of claim 6, wherein the image signal is screen content of the electronic device, or a display content of an audio-video player on a display panel of the electronic device.

9. (canceled)

10. The display device of claim 6, wherein the second communication module and the wireless communication module are Bluetooth communication modules, and the processing circuit is further configured to perform the steps of:
connecting to the electronic device through the second communication module,
wherein the input device is a client, and the display device is a server; and
the steps of connecting to the electronic device through the wireless communication module comprises:
connecting to the electronic device through the wireless communication module, wherein the display device is the client, and the electronic device is the server.

11. The control method of claim 1, wherein the first communication module is a wired communication module.

12. The control method of claim 11, wherein the first communication module comprises a high-definition multimedia interface (HDMI) interface circuit, a displayport (DP) interface circuit or a universal serial bus (USB) type-C interface circuit; and the step of receiving the image signals from the electronic device through the first communication module to display on the display panel comprises:
receiving the image signals from the electronic device through the HDMI interface circuit, the DP interface circuit or the USB type-C interface to display on the display panel.

13. The display device of claim 6, wherein the first communication module is a wired communication module.

14. The display device of claim 13, wherein the first communication module comprises a high-definition multimedia interface (HDMI) interface circuit, a displayport (DP) interface circuit or a universal serial bus (USB) type-C interface circuit; and the step of receiving the image signals from the electronic device through the first communication module to display on the display panel comprises:
receiving the image signals from the electronic device through the HDMI interface circuit, the DP interface circuit or the USB type-C interface to display on the display panel.
